(19) United States
(12) Patent Application Publication
(10) Pub. No.: US 2004/0157049 A1
(43) Pub. Date: Aug. 12, 2004

(54) Grip for racket or the like

(76) Inventor: Hunter Jaw, Lung Ching Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/773,131

(22) Filed: Feb. 5, 2004

Related U.S. Application Data
(63) Continuation-in-part of application No. 09/884,976, filed on Jun. 21, 2001, now Pat. No. 6,720,062.

(51) Int. Cl. B32B 5/02; B32B 27/12; B32B 3/26; B32B 5/18

(52) U.S. Cl. 428/304.4; 442/370; 442/104; 428/318.4

(57) ABSTRACT

A grip is provided for a ratchet. The grip includes a substrate, a coating and bonding points. The substrate is formed of cloth. The coating is formed of latex foam, thermoplastic elastomeric foam, rubber or natural leather. The bonding points are evenly distributed between the substrate and the coating for bonding the substrate and the coating. The bonding points obstruct movement of water from the substrate to the coating when subject to pressure.

### CROSS REFERENCE

The present application is a continuation-in-part application of U.S. patent application Ser. No. 09/884976.

### FIELD OF INVENTION

The present invention relates to a grip including a substrate and a coating securely installed on the substrate via evenly distributed bonding points.

### BACKGROUND OF INVENTION

In general, a handle of a racket or the like is wound with a flexible grip for providing a buffer action to the handle, i.e., reducing vibration or impact exerted on the handle.

Referring to FIG. 1, a conventional grip is a strap 1 wound about a handle of a racket. The strap 1 includes a substrate 3 and a coating 2 installed on the substrate 3. The substrate 3 is made of non-woven cloth. The coating 2 is made of PU material. In fabrication, the substrate 3 is immersed in or coated with a PU solution. The substrate 3 is immersed in water in order to cool the PU solution provided thereon, thus forming the coating 2. Now, the coating 2 and the substrate 3 are saturated with water so as to expand. The strap 1 has to be dried.

Made of materials having different water contents, the coating 2 and the substrate 3 must be dried for different periods of time. Moreover, the coating 2 and the substrate 3 have different rates of contraction so as to entail vulnerable and non-stable combination of the coating 2 with the substrate 3. The coating 2 can easily be separated or stripped from the substrate 3 after being used for some time. Furthermore, the weight of the product of the strap 1 is affected by thickness, water contents, etc. of the coating 2. Hence, the manufacturer cannot estimate and control the weight of the strap product accurately, thereby greatly affecting the quality of the conventional grip.

### SUMMARY OF INVENTION

The present invention has arisen to mitigate or obviate the disadvantage of the conventional grip for a racket.

It is the primary objective of the present invention is to provide a robust grip with a precise size and weight.

According to the present invention, a grip is provided for a ratchet. The grip includes a substrate, a coating and bonding points. The substrate is formed of cloth. The coating is formed of latex foam, thermoplastic elastomeric foam, rubber or natural leather. The bonding points are evenly distributed between the substrate and the coating for bonding the substrate and the coating. The bonding points obstruct movement of water from the substrate to the coating when subject to pressure.

Further benefits and advantages of the present invention will become apparent after a careful study of the detailed description with appropriate reference to the accompanying drawings.

### BRIEF DESCRIPTION OF THE DRAWINGS

FIG. 1 is a perspective view of a conventional grip for a racket.

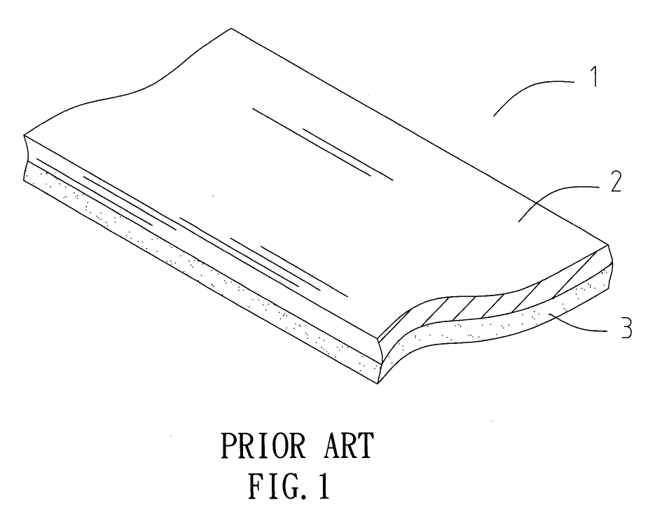

FIG. 2 is an exploded view of a grip for a racket in accordance with the present invention.

FIG. 3 is a cross-sectional view of the grip shown in FIG. 2.

### DETAILED DESCRIPTION OF INVENTION

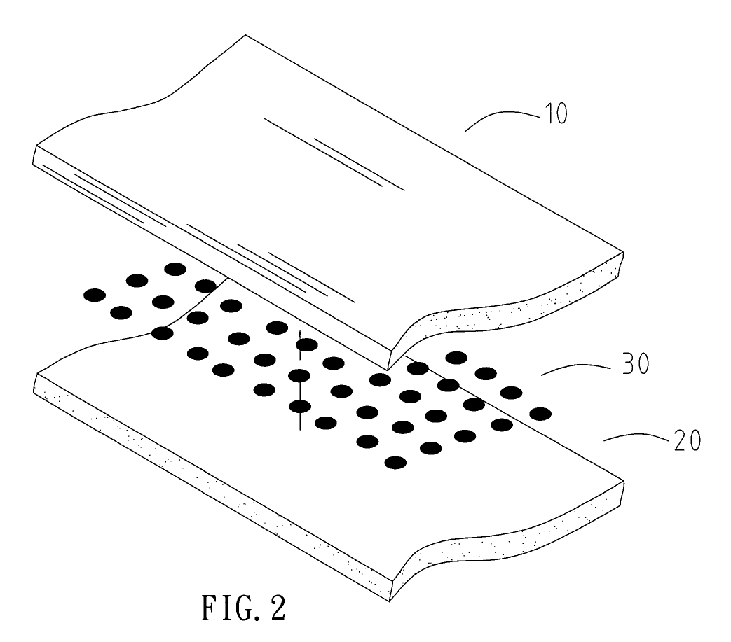

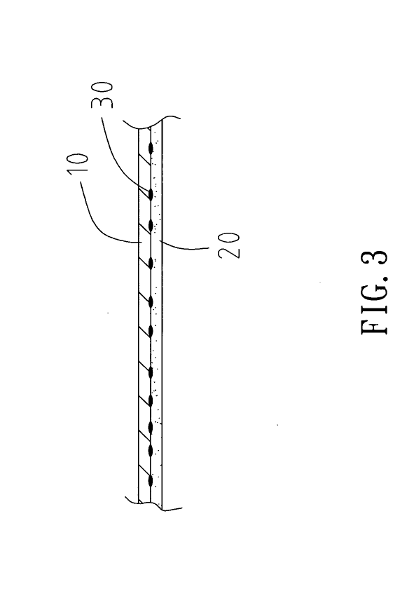

Referring to FIGS. 2 and 3, in accordance with the present invention, a grip for a racket or the like includes a substrate 20 and a coating 10 installed on the substrate 20. A plurality of evenly distributed bonding points 30 is provided between the substrate 20 and the coating 10. The bonding points 30 are preferably adhesive such as thermoplastic gel so as to bond the substrate 20 with the coating 10.

In fabrication, the substrate 20 and the coating 10 are made in advance, and the bonding points 30 are secured to the top face of the substrate 20. Then, the coating 10 is coated on the top face of the substrate 20. The bonding points 30 are finally subject to a heat press process for bonding the substrate 20 and the coating 10. The substrate 20 and the coating 10 are made in advance so that their weights are controlled accurately. The substrate 20 and the coating 10 need not be immersed in water and dried. Thus, the substrate 20 and the coating 10 will not be deformed because of expansion and contraction. The bonding is ensured, i.e., the substrate 20 and the coating 10 will not be stripped from each other easily.

When a user sweats in his or her hand holding the grip, the sweat goes to the substrate 20 from the coating 10 past the bonding points 30. The sweat infiltrates the substrate 20 eventually. When the user tightens his or her grip on the handle, the sweat tends to return to the coating 10 from the substrate 20. Should this happen, the user would feel uncomfortable in the hand. Fortunately, the sweat cannot return to the coating 10 from the substrate 20 immediately because it is obstructed by means of the bonding points 30. Therefore, the user-holds the grip with comfort.

In addition, the coating 10 may be punched with bores or formed with recesses (not shown) so that the sweat can easily infiltrate into the substrate 20 and that the feel of the grip is improved.

The coating 10 is made of latex foam, thermoplastic elastomeric foam, rubber or natural leather.

Although the invention has been explained in relation to its preferred embodiment, modifications and variations are possible without departing from the scope of the present invention. The appended claims will cover such modifications and variations that fall within the true scope of the invention.

1. A grip for a ratchet comprising a substrate formed of cloth, a coating formed of one of latex foam, thermoplastic elastomeric foam, rubber and natural leather and bonding points evenly distributed between the substrate and the coating for bonding the substrate and the coating, the bonding points obstructing movement of water from the substrate into the coating when subject to pressure.

2. The grip according to claim 1 wherein the cloth is non-woven.

3. The grip according to claim 1 wherein the bonding points are adhesive.

4. The grip according to claim 3 wherein the adhesive is thermoplastic gel.

5. The grip according to claim 4 wherein the cloth is non-woven.
